(19) United States
(12) Patent Application Publication
(10) Pub. No.: US 2023/0124682 A1
(43) Pub. Date: Apr. 20, 2023

(54) AUTOMATIC DISTRIBUTION OF FAULT-FINDING AMONG REMOTE SERVICE ENGINEERS

(71) Applicant: KONINKLIJKE PHILIPS N.V., Eidhoven (NL)

(72) Inventors: Tiblets Zeray DEMEWEZ, EINDHOVEN (NL); Mauro BARBIERI, EINDHOVEN (NL); Jurgen Jan RUSCH, EINDHOVEN (NL); Milosh STOLIKJ, EINDHOVEN (NL)

(21) Appl. No.: 17/965,874

(22) Filed: Oct. 14, 2022

Related U.S. Application Data
(60) Provisional application No. 63/257,646, filed on Oct. 20, 2021.

(51) Int. Cl. G06Q 10/06; G06F 9/451; G06Q 10/00

(52) U.S. Cl. CPC G06Q 10/06316; G06F 9/451; G06Q 10/20

(57) ABSTRACT

A non-transitory computer readable medium (107, 127) stores a fault-finding tree (130) comprising data related to a maintenance issue of one or more medical imaging devices (120), and instructions readable and executable by at least one electronic processor (101, 113) to: fill in information for nodes (132) of the fault-finding tree which can be completed to identify tasks to be performed for a current service case involving a current medical imaging device; divide the tasks to be performed into a plurality of groups; assign each group to a corresponding service engineer (SE) to perform the tasks in the group; and display, on a display device (105) of a remote electronic processing device (102) operable by the SE, a user interface (UI) (138) showing assignments of the groups to the corresponding SEs.

### CROSS REFERENCE TO RELATED APPLICATIONS

This application claims the benefit of U.S. Provisional Pat. Application Number 63/257,646 filed Oct. 20, 2021. The application is hereby incorporated by reference herein.

### FIELD

The following relates generally to the medical device maintenance arts, medical imaging device maintenance arts, medical device maintenance and task distribution arts, and related arts.

### BACKGROUND

Customer services for medical systems, such as magnetic resonance imaging (MRI), a computed tomography (CT), a positron emission tomography (PET), interventional radiology (IR), or other medical imaging systems, can require reactive, proactive, and predictive maintenance services. Because these services rely heavily on data, availability of a reliable infrastructure that acquires, processes and stores data from medical systems and other sources is crucial. When there is a problem with a medical system, customers can report the issue to the customer service center via various channels (e.g., by phone, customer portal or mobile application). Then, service engineers (SEs - which can include remote SEs (RSEs) and field SEs (FSEs)) can perform system diagnostics to identify the root-cause of the problem and resolve the issue. Both activities may be performed remotely or on-site, by different SEs. In addition to reactive maintenance as described above, proactive, and predictive diagnostic models are built to identify failure of a system or a part of a system. The output of the diagnostic models is communicated to RSEs, in a form of alert, using a service delivery platform. The RSEs act on the alerts to provide maintenance services.

Customers can call a vendor of the medical device, or other maintenance service provider, when they encounter an issue. An RSE troubleshoots the issue to find a possible solution remotely and/or assigns the right field service engineer to go onsite. A fixed number of RSEs are typically assigned per day to resolve all issues reported by customers. One RSE is assigned to resolve one issue at a time.

However, customer issues may come in at arbitrary moments throughout a day. To resolve these issues, a fixed number of RSEs are allocated. The amount of time to resolve an issue varies enormously. Some issues are resolved quickly, and others take hours. As a result, one RSE may be busy for hours; whereas other RSEs may be idle while waiting for another customer issue.

The following discloses certain improvements to overcome these problems and others.

### SUMMARY

In one aspect, a non-transitory computer readable medium stores a fault-finding tree comprising data related to a maintenance issue of one or more medical imaging devices, and instructions readable and executable by at least one electronic processor to: fill in information for nodes of the fault-finding tree which can be completed to identify tasks to be performed for a current service case involving a current medical imaging device; divide the tasks to be performed into a plurality of groups; assign each group to a corresponding service engineer (SE) to perform the tasks in the group; and display, on a display device of a remote electronic processing device operable by the SE, a user interface (UI) showing assignments of the groups to the corresponding SEs.

In another aspect, a non-transitory computer readable medium stores a fault-finding tree comprising data related to a maintenance issue of one or more medical imaging devices, and instructions readable and executable by at least one electronic processor to: fill in information for nodes of the fault-finding tree which can be completed to identify tasks to be performed for a current service case involving a current medical imaging device; divide the tasks to be performed into a plurality of groups; assign each group to a corresponding SE to perform the tasks in the group; display, on a display device of a remote electronic processing device operable by the SE, a UI showing assignments of the groups to the corresponding SEs; and display, on an electronic processing device operable by a lead SE, an overview dashboard showing progress of the tasks to be performed in each group by the corresponding SEs.

In another aspect, a non-transitory computer readable medium stores a fault-finding tree comprising data related to a maintenance issue of one or more medical imaging devices, and instructions readable and executable by at least one electronic processor to: fill in information for nodes of the fault-finding tree which can be completed to identify tasks to be performed for a current service case involving a current medical imaging device; divide the tasks to be performed into a plurality of groups; assign each group to a corresponding SE to perform the tasks in the group; display, on a display device of a remote electronic processing device operable by the SE, a UI showing assignments of the groups to the corresponding SEs; and upon an indication that one or more of the tasks are completed, updating the UI to update the tasks to be performed.

One advantage resides in minimize an amount of time spent to resolve an issue with a medical device by creating a team of RSEs that address one issue at a time.

Another advantage resides in minimizing time to resolve a service issue for a medical device.

Another advantage resides in assigning an RSE to oversee tasks performed by other RSEs to resolve a maintenance issue for a medical device.

Another advantage resides in a faster resolution time for a maintenance issue of a medical device.

Another advantage resides in reduced idle time for RSEs and for a maintenance issue with a medical device.

Another advantage resides in assigning tasks of a maintenance issue with a medical to device to RSEs having expertise in performing the tasks.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an illustrative system for determining a root cause and at least one recommended service action for servicing a medical device in accordance with the present disclosure.

FIGS. 2 and 3 show exemplary flow chart operations of the system of FIG. 1.

FIG. 4 shows an example of a fault-finding tree used by the system of FIG. 1.

### DETAILED DESCRIPTION

Current medical device vendors can use a combination of customer service representatives (SEs), such as Remote Service Engineers (RSEs), and field service engineers (FSEs), to resolve customer service calls reporting malfunctions in medical imaging devices. A service representative typically is the initial point of customer contact. A service case is opened and passed to an RSE who discusses the malfunction with the customer, retrieves the machine log files, and takes in information on a standardized graphical user interface (GUI) intake dialog. The RSE then attempts to resolve the issue without dispatching an FSE. If resolution of the malfunction is difficult, then the RSE follows a fault-finding plan, which is typically constructed as a fault-finding tree. Various branches of the tree may be followed based on decisions made at various nodes of the tree. These decisions are based on contents of the machine logs and/or information obtained from the customer. The malfunction resolution process can take a lot of time, during which the RSE is unavailable for other tasks. At the same time, other RSEs may be idle. Even further, the RSE who takes up a customer call may have less expertise in an aspect of the fault resolution process than some other RSEs who may be currently idle.

The following discloses to a system for breaking the fault-finding plan into tasks that can be performed concurrently and distributing those tasks amongst multiple RSEs. A lead RSE is also designated to coordinate the overall fault-finding efforts.

The disclosed system includes an automatic diagnostic component that retrieves the fault-finding tree and fills in information for nodes which can be completed using the available information obtained from the customer and/or directly obtainable from the log files. Nodes or branches that cannot be traversed due to lack of information or the need for expert RSE analysis are identified by the automatic diagnostic component. This diagnostic analysis produces a fault-finding plan, which identifies specific tasks to be performed to resolve the malfunction.

In some embodiments disclosed herein, a work divider component then breaks the tasks to be performed into groups that can be performed concurrently. Commonly, the separation of tasks into groups is component-based, i.e., all tasks relating to a particular component of the medical imaging device may be assigned to a single group. Also, if two (or more) tasks depend on one another such that they cannot be performed concurrently then they are assigned to a single group, since that way the first task of the sequence of tasks can be started immediately.

In some embodiments disclosed herein, a resource allocator assigns an RSE to handle the tasks of each group. The RSE assignments can be based on RSE availability (determined for example, by referencing an electronic calendar/phone system), and/or based on RSE expertise, e.g., assigning tasks to RSEs who are indicated in the system as having expertise in those task areas.

In some embodiments disclosed herein, the disclosed system further includes a user interface (UI) that communicates tasks to the assigned RSEs, enables RSEs to indicate when tasks are completed and the results of those tasks, and provides an overview dashboard to the lead RSE overseeing the overall malfunction resolution process. The dashboard of the lead RSE shows the tasks and assigned RSEs, and the task status of each task. Optionally, the dashboard may also display a graphical representation of the fault-finding plan or some summary thereof.

In some embodiments disclosed herein, the results of completed tasks are also optionally fed back to the automatic diagnostic component, which then updates the fault-finding tree based on the additional information provided by the completed tasks, to dynamically update the tasks to be performed. This could involve removing originally assigned but uncompleted tasks that are made unnecessary by results of other tasks or adding new tasks. The work divider then updates the tasks groupings and may reallocate tasks amongst the RSEs.

In other embodiments disclosed herein, if an RSE who is assigned a task becomes unavailable, for example due to receiving another customer call, then the work divider can be invoked to reassign the task of the newly unavailable RSE to another RSE who is available.

It will be appreciated that various of the foregoing aspects may be usefully employed, while other aspects may be omitted, in a specific implementation. Advantages of the disclosed system can include, for example, faster resolution time for customer calls, reducing RSE idle time, enforcing collaboration amongst RSEs, and preferentially assigning tasks to RSEs with expertise in those tasks.

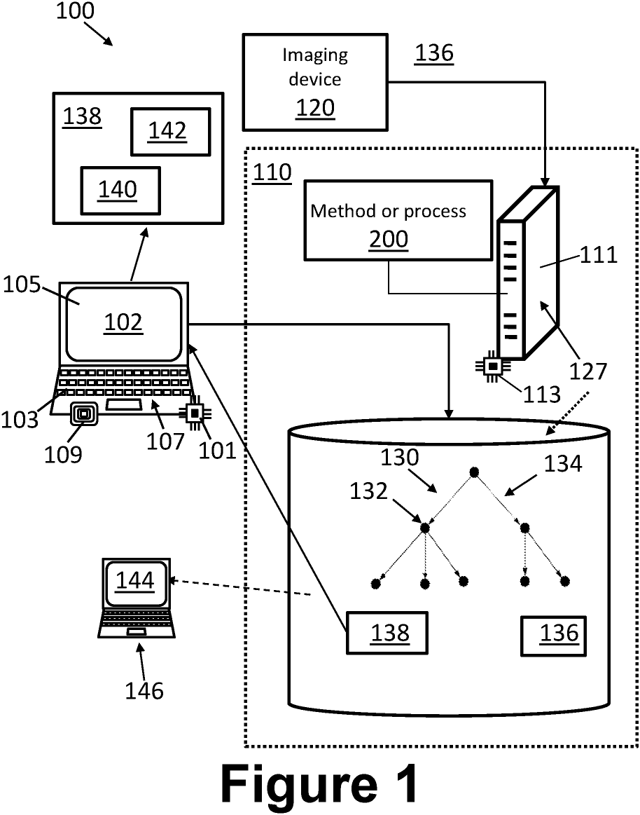

With reference to FIG. 1, an illustrative servicing support system 100 for supporting a service engineer in servicing a device 120 (e.g., a medical imaging device - also referred to as a medical device, an imaging device, imaging scanner, and variants thereof) is diagrammatically shown. By way of some non-limiting illustrative examples, the medical imaging device under service may be a magnetic resonance imaging (MRI) scanner, a computed tomography (CT) scanner, a positron emission tomography (PET) scanner, a gamma camera for performing single photon emission computed tomography (SPECT), an interventional radiology (IR) device, or so forth. (More generally, the disclosed approach can be applied in conjunction with any type of computerized device that automatically generates log data that are analyzed by predictive models to predict component failures, e.g., the approach could be applied to a commercial airliner, radiation therapy device, or so forth). As shown in FIG. 1, the servicing support system 100 includes, or is accessible by, a service device 102 that may for example be a workstation or electronic processing device used by an RSE. The service device 102 may for example be a portable device such as a notebook computer that is carried or accessed by an RSE. The service device 102 can be a desktop computer or a personal device, such as a mobile computer system such as a laptop or smart device. In other embodiments, the service device 102 may be an imaging system controller or computer integral with or operatively connected with the imaging device undergoing service (e.g., at a medical facility). As another example, the service device 102 may be a portable computer (e.g., notebook computer, tablet computer, or so forth) carried by a RSE performing diagnosis of a fault with the imaging device and ordering of parts. In another example, the service device 102 may be the controller computer of the imaging device under service, or a computer based at the hospital. In other embodiments, the service device may be a mobile device such as a cellular telephone (cellphone) or tablet computer.

The service device 102 includes a display 105 via which alerts generated by predictive failure models are displayed, along with likely root cause and service action recommendation information as disclosed herein. The service device 102 also preferably allows the service engineer to interact with the servicing support system via at least one user input device 103 such a mouse, keyboard, or touchscreen. The service device further includes an electronic processer 101 and non-transitory storage medium 107 (internal components which are diagrammatically indicated in FIG. 1). The non-transitory storage medium 107 stores instructions which are readable and executable by the electronic processor 101 for interfacing with the servicing support system 100. The service device 102 also includes a communication interface 109 to communicate with a backend server or processing device 111, which typically implements the computational aspects of the servicing support system 100 (e.g., the server 111 has the processing power for implementing computationally complex aspects of the servicing support system 100). Such communication interfaces 109 include, for example, a wired and/or wireless Ethernet interface (e.g., in the case in which the service device 102 is a RSE workstation); or in the case in which the service device 102 is a portable FSE device the interface 109 may be a wireless Wi-Fi or 4G/5G interface or the like for connection to the Internet and/or an intranet. Some aspects of the servicing support system 100 may also be implemented by cloud processing or other remote processing (that is, the server computer 111 may be embodied as a cloud-based computing resource comprising a plurality of interconnected servers).

In illustrative FIG. 1, the servicing support system further includes a backend 110 (e.g., implemented and/or owned by the imaging device vendor or leased by the vendor from a cloud computing service provider). The backend 110 receives log data (e.g., a machine log automatically generated by the medical imaging device 120, a service log for the medical imaging device 120, and/or so forth) on a continuous or occasional basis (e.g., in some setups the imaging device 120 uploads machine log entries to the backend 110 on a daily basis). The backend processing for performing predictive fault modeling and (as disclosed herein) maintenance service analyses is performed on the backend server 111 equipped with an electronic processor 113 (diagrammatically indicated internal component). The server 111 is equipped with non-transitory storage medium 127 (internal components which are diagrammatically indicated in FIG. 1). While a single server computer is shown, it will be appreciated that the backend 110 may more generally be implemented on a single server computer, or a server cluster, or a cloud computing resource comprising ad hoc-interconnected server computers, or so forth. Furthermore, while FIG. 1 shows a single medical imaging device 120, more generally the database backend 110 will receive log data from many medical imaging devices (e.g., tens, hundreds, or more imaging devices) and performs the disclosed processing for each such medical imaging device.

With continuing reference to FIG. 1, the non-transitory computer readable medium 127 stores a fault-finding tree 130. As shown in FIG. 1 which presents a rendering of the fault-finding tree 130, the fault-finding tree 130 includes nodes 132 (depicted as circles) and edges 134 (depicted as arrows) connecting the nodes. The fault-finding tree 130 contains data related to maintenance issues for the medical imaging device 120, and nodes 132 represent tasks to be performed to address one or more of the maintenance issues.

The non-transitory storage medium 127 stores instructions executable by the electronic processor 113 of the backend server 111 to perform a method 200 of assigning tasks to different RSEs for a current service case for maintenance of the medical imaging device 120.

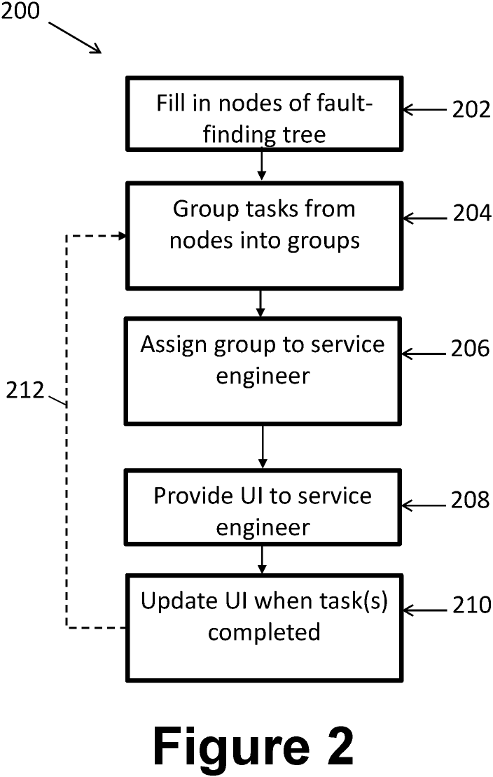

With continuing reference to FIG. 1 and further reference to FIG. 2, an illustrative embodiment of the method 200 executable by the electronic processor 113 is diagrammatically shown as a flowchart. In some examples, the method 200 may be performed at least in part by cloud processing.

To begin the method 200, at an operation 202, a query for a current service case related to the medical imaging device 120 (i.e., a “current” medical imaging device 120) can be received by the backend server 111 (operable by the vendor) from the customer of the medical device 120. Information from this query can be used to fill in the nodes 132 of the fault-finding tree 130, where the filled-in nodes 132 represent tasks identified to be performed for the current service case. In one example, the nodes 132 can be filled in from one or more log files 136 from the medical imaging device 120. In another example, the nodes 132 can be filled in from data entered directly by a customer who the medical imaging device 120, for example using a customer UI 144 displayed on a customer electronic processing device 146 operable by the customer. In some embodiments, one or more nodes 132 can be identified that cannot be filled in (i.e., due to missing or incomplete data), and such nodes 132 can be annotated to indicated that the node cannot be filled in.

At an operation 204, the tasks to be performed (i.e., represented by the nodes 132) can be divided into a plurality of groups. In some embodiments, the dividing operation 204 can include grouping at least two tasks (i.e., nodes 132) into a single group based on a determination that the at least two tasks cannot be performed concurrently.

At an operation 206, each group is assigned to a corresponding SE to perform the tasks in the group. In some embodiments, the assigning operation 204 can include assigning a group based on an availability and/or an expertise of the corresponding SE to perform the tasks in the group.

At an operation 208, a user interface (UI) 138 is transferred to a remote electronic processing device operable by the SE (i.e., the service device 102) for display on the display device 105. The UI 138 shows assignments of the groups to the corresponding SEs. In one example embodiments, the fault-finding tree 130 can also be displayed on the UI 138, along with a progress indicator 140 (i.e., a status bar, a percentage number, and so forth) of the groups having tasks performed by the corresponding SEs. Each SE has a corresponding service device 102 to receive their corresponding UI 138 showing the tasks for that particular SE to perform.

In a particular embodiment, one of the RSEs can be designated as a “lead” RSE who oversees the groups of tasks performed by the other RSEs. The service device 102 of the lead RSE can display a dashboard 142 on the UI 138. The dashboard 142 can show progress of the tasks to be performed in each group by the corresponding SEs.

At an operation 210, upon an indication that one or more of the tasks are completed, the UI 138 can be updated to update the tasks to be performed. This updating operation 210 can include updating the UI 138 on the individual service device 102 of the SE who has completed a task, and also updating the dashboard 142 of the UI 138 of the service device 102 of the lead RSE. In some examples, after this updating operation, the groups can be updated with an updated list of tasks to be performed by flowing back to the operation 204, and these updated groups can be assigned (or reassigned) to a corresponding SE by a subsequent pass through operation 206, as indicated by a dashed flowback arrow 212. In another example, in response to an SE who is assigned to perform the tasks of a group becoming unavailable, the group assigned to the unavailable SE can be reassigned to another SE.

In some embodiments, the customer UI 144 can be displayed on the customer electronic processing device 146 operable by a customer of the medical device 120. (The customer electronic processing device 146 can include substantially similar components as the electronic processing device 102, and thus will not be repeated for brevity). The customer UI 144 can display the fault-finding tree 130, and also how the different tasks represented by the fault-finding tree 130 are allocated to different RSEs. In some examples, the customer UI 144 can receive inputs from the customer (e.g., an onsite technician, a biomedical engineer, and so forth) to provide information about the medical device 120 (e.g., service history information) or conduct one of the “manual” tasks of the current service case (e.g., moving components of the medical device 120 (such as a detector or bed) that can be typically restricted due to on-site safety concerns), or coordinate with the RSE to perform the current service case. In cases where the fault finding tree 130 may contain proprietary information that the vendor does not wish to expose to the customer, the customer UI 144 can suitably display a rendering of the fault-finding tree 130 that omits the proprietary content. If the fault-finding tree 130 as a whole is considered proprietary, then the customer UI 144 may display the tree at a high level so as to be insufficient to extract the overall fault-finding process from the high level representation. In another approach for this situation, only a small portion of the fault-finding tree 130 that is pertinent to the specific diagnostic process may be displayed on the customer UI 144.

### EXAMPLES

The following describes a method that analyses a customer issue to produce a fault plan that can be used to distribute troubleshooting work among RSEs based on their availability. The method takes description of the reported issue and device (i.e., log) data to come up with a fault-finding plan that can be used to identify the logical components or functions in the medical imaging device 120 that need to be analysed. This is followed by the creation of troubleshooting tasks with clear input and output requirements that can later be assigned to the available RSEs. Depending on the reported issue, some of the troubleshooting tasks can be managed in parallel or in series. If the reported issue results in to two or more unrelated issues, the issues will be analysed separately. This method can be integrated within a service system 100 as an automatic task distributor feature.

The disclosed systems and methods also keep track of completion or resolution of the tasks. As soon as a root cause for an issue has been found, a notification is sent to the RSE to stop further troubleshooting. Subsequently, the proposed method updates the availability of RSEs to accurately (re)allocate tasks. Once troubleshooting is complete, the system collects the result from each RSE and reports out to the leading RSE. During troubleshooting, an RSE may be interrupted by another customer call. In this case, the system assigns the task to another available RSE or the lead RSE.

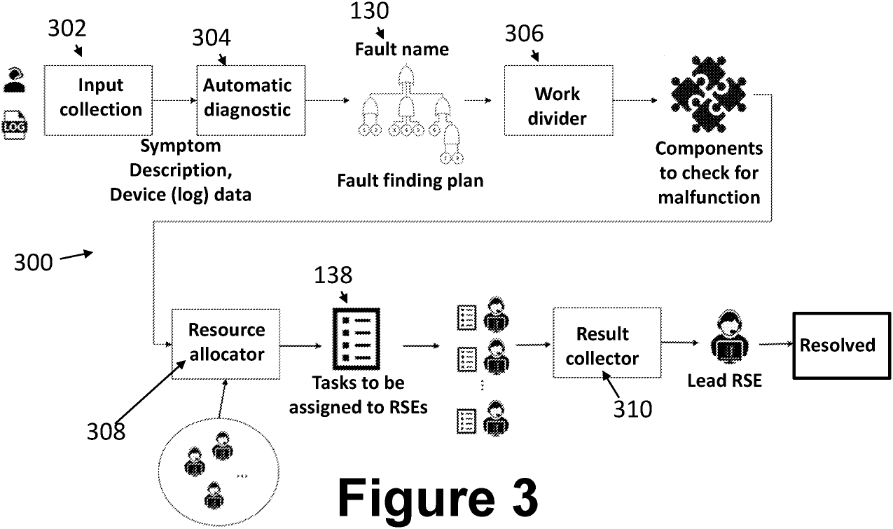

A pictorial representation of the disclosed method 300 is shown in FIG. 3. At an input collection operation 302, all relevant information required to resolve an issue is gathered and organized. The input includes symptom description, device log data, metadata of the medical imaging device 120, etc.

At an automatic diagnostic operation 304 (corresponding to the operation 202 of FIG. 2), the input data is analyzed to generate a fault-finding plan (i.e., filling in the nodes 132 of the fault-finding tree 130). The fault-finding plan reveals a logical relationship of possible events that could have caused the reported issue. It starts from the symptom and drills down into all the possible events in a form of the fault-finding tree 130. In case multiple problems detected, the automatic diagnostic operation 304 makes multiple fault-finding plans, that can be investigated in parallel.

At a work divider operation 306, the fault-finding tree 130 is used to produce a list of components that might have malfunctioned. In a first example, the fault-finding tree 130 is checked to ensure that enough metadata is provided to provide enough information to deduce the components of the medical imaging device 120 that could be troubleshooted independently. In a second example, an Artificial Intelligent (AI) algorithm based on Natural Language Processing (NLP) is built and trained using historical fault-finding tree plans with similar context. This algorithm can then be used to identify components of the medical imaging device 120 that need to be troubleshooted given a fault-finding tree 130 for a given issue.

At a resource allocator operation 308, the list of components that might have malfunctioned and the list of available RSEs to produce a list of tasks associated with the identified components. These tasks are assigned to several RSEs. The RSEs will execute the tasks in parallel and/or in series based on the defined relationship between the tasks and pass the outcome of the troubleshooting.

At a result collector operation 310, outcomes of the troubleshooting from the assigned RSEs are complied, and reported to the lead RSE. The lead RSE reviews and determines whether the issue is resolved or not. In case of incomplete troubleshooting, the lead RSE reports part of the unsolved issue.

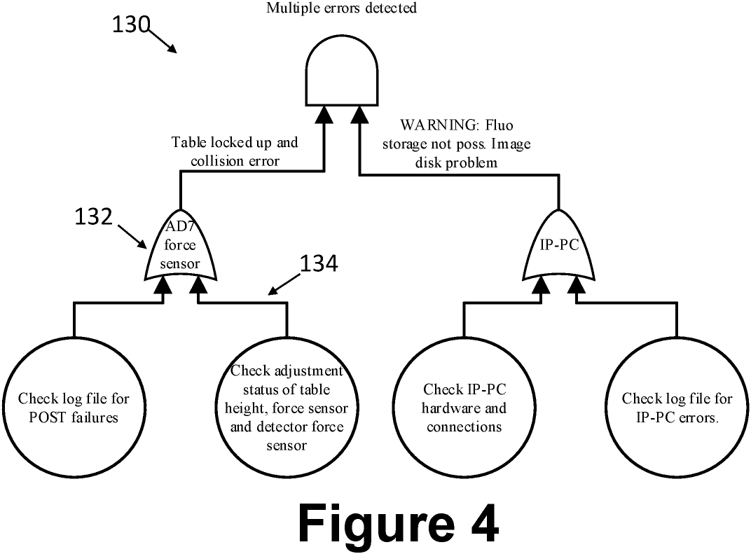

FIG. 4 shows an example of a fault-finding tree (or portion thereof) 130. The fault-finding tree 130 shown in FIG. 4 is for an image-guided therapy (iGT) system as the medical imaging device 120. For example, a customer calls to report the iGT system 120 is not working and the iGT system 120 shows a message: “table locked up and collision error”. The first step is to gather all relevant information including symptoms and device log data 136. The gathered information can be used to generate the fault-finding tree 130. This fault-finding tree 130 provides a logical relationship of probable causes of the reported issue. In this example, the “left side” of the fault-finding-tree 130 relates to the reported problem, while the “right side” of the fault-finding-tree 130 relates to an additional issue found in the log data.

The work divider operation 306 is performed to provides components to check for malfunction. In this case, it identifies two components with potential issues: an AD7 sensor and the IP-PC (shown as a “middle row” of nodes 132 in FIG. 4). For both components, the resource allocator operation 308 is performed to create tasks that can be assigned to RSEs (shown as a “bottom” row of nodes 132). The task breakdown and the possible outcome of the troubleshooting can be given as:

### Component 1

Task 1: Check log file for POST failures (RSE1).

Task 2: Check adjustment status of table height, force sensor and detector force sensor (RSE2).

### Component 2

Task 3: Contact customer to: “Check the back of the IP-PC, there are 8 green LEDs indicating the boot status of the PC. Please refer known issue document for the LED status details. If LED status is normal, then issue is probably network related. Check wiring between Host PC and IP-PC and perform Cold reboot of the system. If LED status is not Normal then issue is Boot problem in IP-PC, perform cold reboot of the system and replace IP-PC if problem persists/repeats.” (RSE3).

Task 4: Check log files for IP-PC problems (RSE4)

### Outcome

Task 1, RSE1: AD7 sensor errors detected. Action: replace AD7 FORCE SENSOR

Task 2, RSE2: No errors.

Task 3, RSE3: No errors.

Task 4, RSE4: IP-PC cannot boot. Action: Replace IP-PC, image discs, and OS disc

Based on these tasks, the lead RSE makes sure each issue is resolved.

To illustrate the utilization of RSEs, consider a certain day d and let C = {c₁, c₂, ..., cₙ} be set of customer calls received to report issues on day d. These calls arrive arbitrarily distributed over time throughout the day without a specific order. Let E = {e₁, e₂, ..., eₘ} be the set of RSEs available to resolve customer issues on day d. Let f(cᵢ, eⱼ) be the time required to solve customer issue cᵢ by engineer eⱼ. The total time spent to resolve all the issues per day is given by Equation 1:

$$T = {\sum }_{i = 1}^{n} {\sum }_{j = 1}^{m} f \left({c}_{i} , {e}_{j}\right)$$

A customer call cᵢ results in a number of tasks S = {s₁, s₂, ..., sₖ} and assigned to r RSEs. The number of tasks, k, depends on the reported issue. Let g(s_{i,} eⱼ) be the time required to carry out task sᵢ by engineer eⱼ. The total time spent to resolve an issue reported by a call cᵢ is given by Equation 2:

$${T}_{{c}_{i}} = {\sum }_{l = 1}^{k} {\sum }_{j = 1}^{r} g \left({s}_{l} , {e}_{j}\right)$$

For all the calls received on day d, the amount of time spent would be given as Equation 3:

$$T * = {\sum }_{i}^{n} {T}_{{c}_{i}}$$

As the total time spent to resolve an issue is minimized, then T* < T.

A non-transitory storage medium includes any medium for storing or transmitting information in a form readable by a machine (e.g., a computer). For instance, a machine-readable medium includes read only memory (“ROM”), solid state drive (SSD), flash memory, or other electronic storage medium; a hard disk drive, RAID array, or other magnetic disk storage media; an optical disk or other optical storage media; or so forth.

The methods illustrated throughout the specification, may be implemented as instructions stored on a non-transitory storage medium and read and executed by a computer or other electronic processor.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory computer readable medium storing:
a fault-finding tree comprising data related to a maintenance issue of one or more medical imaging devices; and
instructions readable and executable by at least one electronic processor to:
fill in information for nodes of the fault-finding tree which can be completed to identify tasks to be performed for a current service case involving a current medical imaging device;
divide the tasks to be performed into a plurality of groups;
assign each group to a corresponding service engineer (SE) to perform the tasks in the group; and
display, on a display device of a remote electronic processing device operable by the SE, a user interface (UI) showing assignments of the groups to the corresponding SEs.

2. The non-transitory computer readable medium of claim 1, wherein displaying the UI includes:
displaying the fault-finding tree and progress indicators of the groups having tasks performed by the corresponding SEs.

3. The non-transitory computer readable medium of claim 1, wherein displaying the UI includes:
displaying, on an electronic processing device operable by a lead SE, an overview dashboard showing progress of the tasks to be performed in each group by the corresponding SEs.

4. The non-transitory computer readable medium of claim 1, wherein the instructions further include:
identifying nodes of the fault-finding tree that cannot be filled in; and
annotating the identified nodes.

5. The non-transitory computer readable medium of claim 1, wherein dividing the tasks to be performed into a plurality of groups includes:
grouping at least two tasks into a single group based on a determination that the at least two tasks cannot be performed concurrently.

6. The non-transitory computer readable medium of claim 1, wherein assigning a group to a corresponding SE includes:
assigning a group based on an availability and/or an expertise of the corresponding SE to perform the tasks in the group.

7. The non-transitory computer readable medium of claim 1, wherein the instructions further include:
upon an indication that one or more of the tasks are completed, updating the UI to update the tasks to be performed.

8. The non-transitory computer readable medium of claim 7, wherein the instructions further include:
after the updating, updating the groups with an updated list of tasks to be performed; and
assigning the updated groups to a corresponding SE.

9. The non-transitory computer readable medium of claim 1, wherein the instructions further include:
in response to an SE who is assigned to perform the tasks of a group becoming unavailable, reassigning the group assigned to the unavailable SE to another SE.

10. The non-transitory computer readable medium of claim 1, wherein filling in information to the nodes includes one or more of:
filling in nodes from one or more log files of the medical imaging device; and
filling in nodes from data entered directly by a customer who owns medical imaging device using a customer UI.

11. A non-transitory computer readable medium storing:
a fault-finding tree comprising data related to a maintenance issue of one or more medical imaging devices; and
instructions readable and executable by at least one electronic processor to:
fill in information for nodes of the fault-finding tree which can be completed to identify tasks to be performed for a current service case involving a current medical imaging device;
divide the tasks to be performed into a plurality of groups;
assign each group to a corresponding service engineer (SE) to perform the tasks in the group;
display, on a display device of a remote electronic processing device operable by the SE, a user interface (UI) showing assignments of the groups to the corresponding SEs; and
display, on an electronic processing device operable by a lead SE, an overview dashboard showing progress of the tasks to be performed in each group by the corresponding SEs.

12. The non-transitory computer readable medium of claim 11, wherein displaying the UI includes:
displaying the fault-finding tree and progress indicators of the groups having tasks performed by the corresponding SEs.

13. The non-transitory computer readable medium of claim 11, wherein the instructions further include:
identifying nodes of the fault-finding tree that cannot be filled in; and
annotating the identified nodes.

14. The non-transitory computer readable medium of claim 11, wherein dividing the tasks to be performed into a plurality of groups includes:
grouping at least two tasks into a single group based on a determination that the at least two tasks cannot be performed concurrently.

15. The non-transitory computer readable medium of claim 11, wherein assigning a group to a corresponding SE includes:
assigning a group based on an availability and/or an expertise of the corresponding SE to perform the tasks in the group.

16. A non-transitory computer readable medium storing:
a fault-finding tree comprising data related to a maintenance issue of one or more medical imaging devices; and
instructions readable and executable by at least one electronic processor to:
fill in information for nodes of the fault-finding tree which can be completed to identify tasks to be performed for a current service case involving a current medical imaging device;
divide the tasks to be performed into a plurality of groups;
assign each group to a corresponding service engineer (SE) to perform the tasks in the group;
display, on a display device of a remote electronic processing device operable by the SE, a user interface (UI) showing assignments of the groups to the corresponding SEs; and
upon an indication that one or more of the tasks are completed, updating the UI to update the tasks to be performed.

17. The non-transitory computer readable medium of claim 16, wherein the instructions further include:
after the updating, updating the groups with an updated list of tasks to be performed; and
assigning the updated groups to a corresponding SE.

18. The non-transitory computer readable medium of claim 16, wherein the instructions further include:
in response to an SE who is assigned to perform the tasks of a group becoming unavailable, reassigning the group assigned to the unavailable SE to another SE.

19. The non-transitory computer readable medium of claim 16, wherein filling in information to the nodes includes one or more of:
filling in nodes from one or more log files of the medical imaging device; and
filling in nodes from data entered directly by a customer who owns medical imaging device using a customer UI.

20. The non-transitory computer readable medium of claim 16, wherein displaying the UI includes:
displaying, on an electronic processing device operable by a lead SE, an overview dashboard showing progress of the tasks to be performed in each group by the corresponding SEs.

21. A non-transitory computer readable medium storing:
a fault-finding tree comprising data related to a maintenance issue of one or more medical imaging devices; and
instructions readable and executable by at least one electronic processor to:
provide a customer UI on an electronic processing device operable by a customer of the one or more medical devices;
receive, via the customer UI, data entered by the customer;
fill in information for nodes of the fault-finding tree which can be completed to identify tasks to be performed for a current service case involving a current medical imaging device from the entered data;
divide the tasks to be performed into a one or more groups;
assign each group of tasks to a corresponding service engineer (SE) to perform the tasks in the group; and
display, on the customer UI, the assignments of the groups for the corresponding tasks and progress of the tasks to be performed in each group by the corresponding SEs.

22. The non-transitory computer readable medium of claim 21, wherein the instructions further include:
display, on a display device of a remote electronic processing device operable by the SE, a user interface (UI) showing assignments of the groups to the corresponding SEs.

23. The non-transitory computer readable medium of claim 21, wherein the instructions further include:
display, on an electronic processing device, operable by a lead service engineer (SE), an overview dashboard showing progress of the tasks to be performed in each group by the corresponding SEs.
